(19) United States
(12) Patent Application Publication
(10) Pub. No.: US 2011/0194101 A1
(43) Pub. Date: Aug. 11, 2011

(54) SUPERSENSITIZATION OF DEFECT INSPECTION METHOD

(76) Inventors: Takehiro Tachizaki, Yokohama (JP); Shun'ichi Matsumoto, Yokohama (JP); Masahiro Watanabe, Yokohama (JP)

(21) Appl. No.: 13/123,906

(22) PCT Filed: Sep. 28, 2009
(86) PCT No.: PCT/JP2009/067295

§ 371 Date: Apr. 13, 2011

(30) Foreign Application Priority Data
Oct. 15, 2008 (JP) 2008 265877

(51) Int. Cl. G01N 21/88

(52) U.S. Cl. 356/72

(57) ABSTRACT

An electron microscope, for observing a defect detected by an optical defect inspection device or an optical appearance inspection device, is configured in such a manner that an optical microscope for re-detecting the defect is mounted thereon, and that a polarization-distribution polarizer and a spatial filter are inserted into a pupil plane when the optical microscope is used to observe a dark field.

### TECHNICAL FIELD

The present invention relates to a device that inspects a defect on a surface of a semiconductor wafer or a surface of a magnetic disk, and more particularly to a defect inspection device that is suitable to inspect a defect or the like on a surface of a bear wafer without a semiconductor pattern, a surface of a wafer provided with a film and without a semiconductor pattern, or a surface of a disk.

### BACKGROUND ART

For example, in a process of manufacturing a semiconductor device, when a foreign material or a defective pattern (hereinafter referred to as a defect, but including a foreign material and a defective pattern) such as a short circuit or a disconnection is present on a semiconductor substrate (wafer), the defect may cause a failure of insulation of a line, a failure such as a short circuit, or the like. In addition, the size of a circuit pattern that is formed on the wafer has been reduced. Thus, a fine defect may cause a failure of insulation of a capacitor or damage a gate oxide film or the like. These defects may occur from a moving unit of a carrier device, or occur from a human body, or react with process gas in a processing device and occur in the processing device, or exist in a chemical or a material. The defects may be mixed into the chemical or the material in various states for various reasons. It is, therefore, important to detect a defect generated in the manufacturing process, identify the source of the defect, and prevent a production of a defective product in order to mass-produce the semiconductor device.

Among methods for tracing a cause of the occurrence of a defect, there was the following traditional method. First, the position of a defect is specified by a defect inspection device. The defect is observed in detail and classified using a scanning electron microscope (SEM) or the like. Then, the defect is compared with a database, and the cause of the occurrence of the defect is estimated.

The defect inspection device may be an optical defect inspection device that illuminates the surface of a semiconductor substrate with a laser beam, performs a dark-field observation on light scattered from a defect and specifies the position of the defect. In addition, the defect inspection device may be an SEM inspection device or an optical appearance inspection device, which irradiates the surface of the semiconductor substrate with lamp light, a laser beam or an electron beam, detects a bright-field optical image of the semiconductor substrate, compares the image with reference information, and specifies the position of the defect present on the semiconductor substrate. The observation methods are disclosed in Patent Document 1 (JP-A-7-270144) or Patent Document 2 (JP-A-2000-352697).

In addition, for a device that observes a defect in detail using an SEM, Patent Document 3 (U.S. Pat. No. 6,407,373), Patent Document 4 (JP-A-2007-71803) and Patent Document 5 (JP-A-2007-235023) describe a method and device for causing an optical microscope attached to an SEM-type defect inspection device to detect the position of a defect using positional information about the defect on a sample detected by another inspection device, modifying the information on the position of the defect detected by the other inspection device, and observing (reviewing) the defect in detail using an SEM-type defect observation device, and a technique for optically detecting the vertical position of the surface of the sample and matching the surface of the sample with the position of a focal point of the SEM in order to observe a defect using the SEM-type defect observation device.

### SUMMARY OF THE INVENTION

### Problems To Be Solved By the Invention

In order to detect a defect on the surface of a semiconductor substrate using an optical defect inspection device and increase the efficiency of an inspection, the defect inspection device scans and irradiates the surface of the semiconductor substrate while increasing the size of a spot of a laser beam with which a dark-field illumination is performed on the surface of the semiconductor substrate. Thus, positional coordinates that are calculated from the position of the spot of the laser beam with which the surface of the semiconductor substrate is scanned include a large error component.

When the defect is to be observed in detail using the SEM on the basis of the information that indicates the position of the defect and includes the large error component, the defect to be observed may not exist in a field of view of the SEM that performs an observation with a much higher magnification than the optical defect inspection device. In this case, the substrate is moved so that an image of the defect to be observed is located in the field of view of the SEM, and the defect is searched. However, it takes a long time to search the defect, and this reduces the efficiency of the observation using the SEM.

An object of the present invention is to provide a defect observation device that can be formed in a compact shape and is capable of detecting, with high sensitivity, a fine defect detected by an optical defect inspection device or an optical appearance inspection device and reliably setting the defect in a field of view of an SEM in order to observe, in detail, the defect detected by the optical defect inspection device or the optical appearance inspection device using the SEM.

### Means for Solving the Problems

In order to accomplish the aforementioned object, according to the present invention, a defect observation device comprises: optical microscope means; SEM observation means; and stage means that holds a sample and is capable of moving between the optical microscope means and the SEM observation means; the defect observation device observing a defect on the sample using positional information about the defect on the sample, the defect on the sample having originally been detected by other inspection device, includes: optical microscope means; SEM observation means; and stage means that holds a sample and is capable of moving between the optical microscope means and the SEM observation means, wherein an optical system means includes a dark-field illumination optical system that detects the defect by a dark-field illumination using the positional information about the defect on the sample detected by the other inspection device, and wherein the dark-field illumination optical system includes: a polarized-light illuminating section that illuminates the sample with polarized light; and a detection optical system that detects light reflected and scattered from the sample illuminated with the polarized light by the polarized-light illuminating section while shielding or reducing a specific polarized component of the reflected and scattered light.

In order to accomplish the aforementioned object, according to the present invention, a defect observation method, in which an optical microscope detects the position of a defect using positional information about the defect on a sample, the defect on the sample having originally been detected by other inspection device, the positional information about the defect on the sample detected by the other inspection device is modified, and the defect whose positional information has been modified is observed by an SEM, includes the steps of: causing the optical microscope to perform a dark-field illumination with polarized light using the positional information about the defect on the sample detected by the other inspection device; and detecting light reflected and scattered from the sample illuminated by the dark-field illumination with the polarized light while shielding or reducing a specific polarized component of the reflected and scattered light, and thereby detecting the defect on the sample detected by the other inspection device.

### Effect of the Invention

According to the present invention, in order to observe in detail a defect detected by an optical defect inspection device using an SEM or the like, the defect to be observed can be reliably set in a field of view of the SEM or the like, and the efficiency to inspect in detail the defect using the SEM or the like can be improved. In addition, the device can be formed in a compact shape and configured with low cost.

### BRIEF DESCRIPTION OF THE DRAWINGS

FIG. 1 is a diagram showing an example of a configuration of a surface inspection device according to a first embodiment of the present invention.

FIG. 2 is a diagram showing a dark-field illumination unit according to the first embodiment of the present invention in detail.

FIG. 3 is a diagram showing an optical vertical position detection device according to the first embodiment of the present invention in detail.

FIG. 4 is a diagram showing an optical microscope according to the first embodiment of the present invention in detail.

FIG. 5 is a diagram showing a mechanism for switching distribution polarization elements according to the first embodiment of the present invention in detail.

FIG. 6 is a diagram showing another example of the mechanism for switching the distribution polarization elements according to the first embodiment of the present invention in detail.

FIGS. 7(a) and 7(b) are diagrams showing examples of the directions of distributed transmission axes of the distribution polarization element to be inserted in a pupil plane of the optical microscope according to the first embodiment of the present invention.

FIGS. 8(a) to 8(d) are diagrams showing examples of the shape of a spatial filter to be inserted in the pupil plane of the optical microscope according to the first embodiment of the present invention.

FIG. 9 is a diagram showing scattered-light simulation performed in order to determine an optical characteristic of the distribution polarization element and an optical characteristic of the spatial filter according to the first embodiment of the present invention.

FIGS. 10(a) to 10(f) are diagrams showing examples of the results of the scattered-light simulation performed in order to determine the optical characteristic of the distribution polarization element and the optical characteristic of the spatial filter according to the first embodiment of the present invention.

FIG. 11 is a diagram showing an example of the directions of distributed transmission axes of the distribution polarization element to be inserted in the pupil plane of the optical microscope according to the first embodiment of the present invention.

FIGS. 12(a) and 12(b) are diagrams showing an example of the distribution polarization element and the spatial filter, which are inserted in the pupil plane of the optical microscope and formed on the same substrate according to the first embodiment of the present invention.

FIG. 13 is a diagram showing an image that is used to calculate a deviation of the position of a defect and acquired by a dark-field observation performed by the optical microscope according to the first embodiment of the present invention.

FIG. 14 is a diagram showing procedures of a process of observing a defect according to the first embodiment of the present invention.

FIGS. 15(a) and 15(b) are diagrams showing procedures of a process of calculating a Z position according to third and fourth embodiments of the present invention.

FIG. 16 is a diagram showing a second example of the configuration of the optical microscope according to the first embodiment of the present invention.

FIG. 17 is a diagram showing a third example of the configuration of the optical microscope according to the first embodiment of the present invention.

FIG. 18 is a diagram showing an example of a configuration of a surface inspection device according to a second embodiment of the present invention.

FIG. 19 is a diagram showing an example of a configuration of a surface inspection device according to the third embodiment of the present invention.

FIG. 20 is a diagram showing an example of a configuration of a surface inspection device according to the fourth embodiment of the present invention.

### DESCRIPTION OF THE REFERENCE NUMERALS

1 . . . Sample
2 . . . Sample holder
3 . . . Stage
4 . . . Optical vertical position detecting device
5 . . . Electron microscope
6 . . . Vacuum chamber
7 . . . Optical vertical position detecting device
10 . . . Control system
11 . . . User interface
14 . . . Optical microscope
101 . . . Dark-field illumination unit
102 . . . vertically reflection mirror
104 . . . Mirror
105 . . . Objective lens
106 . . . Vertical position control mechanism
108 . . . Half mirror
109 . . . Bright-field illumination light source
110 . . . Imaging optical system
111 . . . Solid-state imaging element
113 . . . Lens group
114 . . . polarization-distributed polarizer
116 . . . Imaging lens
117 . . . Objective lens rotating mechanism
118 . . . Liquid crystal control device
501 . . . Illumination light source
502 . . . Optical filter
503 . . . Wavelength plate
507 . . . Lens group
701 . . . Light source
702 . . . Condenser lens
703 . . . Slit
704 . . . Light projecting lens
705 . . . Condenser lens
706 . . . Detector
401 . . . Filter switching mechanism
402 . . . Holder
405 . . . Distribution polarization element holder

### BEST MODE FOR CARRYING OUT THE INVENTION

Embodiments of the present invention are described below with reference to the accompanying drawings.

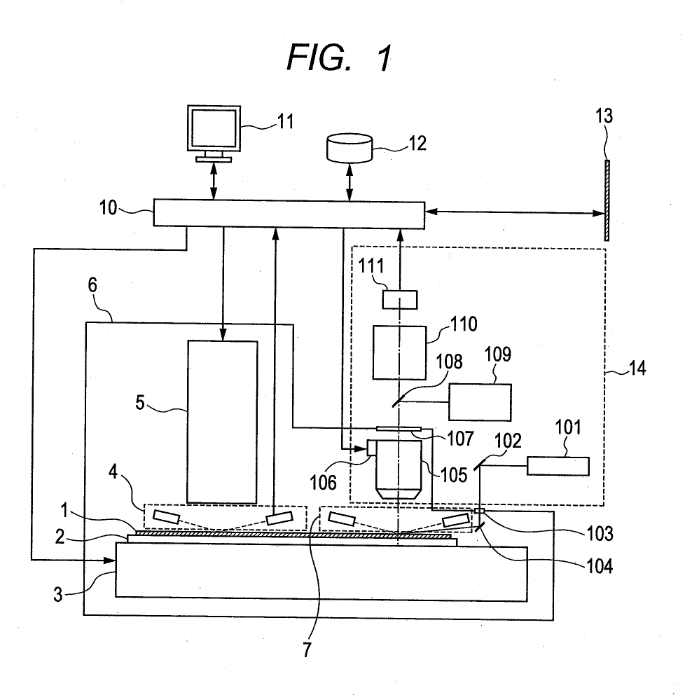

FIG. 1 shows an example of a configuration of a defect detection device according to an embodiment of the present invention. The defect detection device according to the present embodiment is a device that observes a defect that occurs in a device manufacturing process of forming a circuit pattern on a substrate (wafer) of a semiconductor device or the like. The defect detection device according to the present embodiment includes: a wafer 1 to be inspected; a sample holder 2 that holds the sample thereon; a stage 3 capable of moving the sample holder 2 so that the entire surface of the sample 1 is set under a microscope; a scanning electron microscope (hereinafter referred to as an SEM) 5 that observes in detail the wafer 1 to be inspected; an optical vertical position detection system (hereinafter referred to as a Z sensor) 4 that sets a focal point of the electron microscope 5 on the surface of the sample 1; an optical microscope 14 that optically redetects a defect present on the sample 1 and acquires detailed information on the position of the defect present on the sample 1; a Z sensor 7 that adjusts a focal point of the optical microscope 14; a vacuum chamber 6 that houses the electron microscope 5 and an objective lens 105 of the optical microscope 14; a control system 10 that controls the electron microscope 5, the Z sensor 4, the Z sensor 7, a vertical position control mechanism 106 and a solid-state imaging element 111; an user interface 11; a database 12; and a network 13 that provides a connection to a host system such as an optical defect inspection device.

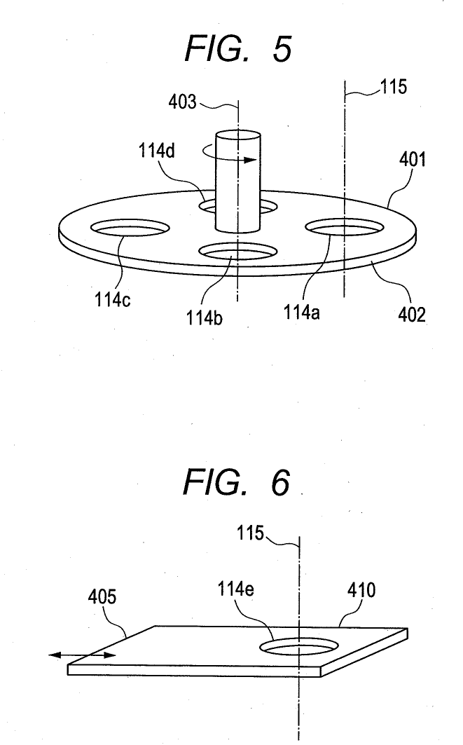

In addition, the optical microscope 14 includes: a dark-field illumination unit 101; an vertically reflection mirror 102 that guides, to the vacuum chamber, a laser beam emitted from the dark-field illumination unit 101 and controls the position of a spot of the laser beam on the surface of the sample 1; a vacuum sealing window 103; a mirror 104; the objective lens 105 that receives light scattered from the sample 1 or is used for a bright-field observation; the mechanism 106 for controlling the vertical position of the objective lens; a vacuum sealing window 107; a half mirror 108 that introduces an illumination necessary for the bright-field observation; a bright-field illumination light source 109; an imaging optical system 110 that images the sample 1 onto the solid-state imaging element; the solid-state imaging element 111; and a mechanism 401 (refer to FIG. 5) for switching a polarization-distributed polarizer and a spatial filter. The stage 3, the Z sensors 4 and 7, the SEM 5, the user interface 11, the database 12, the vertical position control mechanism 106 and the solid-state imaging element 111 are connected to the control system 10. The control system 10 is connected to the host system (not shown) through the network 13.

In the thus-configured defect observation device, the optical microscope 14 has a function of redetecting (hereinafter referred to as detecting) the position of a defect on the sample 1 detected by an optical defect inspection device (not shown) using information on the position of the defect detected by the optical defect inspection device. The vertical position control mechanism 106 and the Z sensor 7 have a function of focusing on the sample as focusing means. The control system 10 has, as position correcting means, a function of correcting the information on the position of the defect on the basis of the information on the position of the defect detected by the microscope 14. The SEM 5 has a function of observing the defect whose positional information has been corrected by the control system 10. The stage 3 that holds thereon the wafer 1 to be inspected moves between the optical microscope 14 and the SEM 5 so that the SEM 5 can observe the defect detected by the optical microscope 14.

The objective lens 105 and the vertical position control mechanism 106 are arranged in the vacuum chamber 6. The vertical position control mechanism 106 may have any of the following configurations: a configuration in which a piezoelectric element is used to move the objective lens; a configuration in which a stepping motor and a ball screw are used to move the objective lens along a linear guide in Z direction (direction of an optical axis 115 of the imaging optical system 110); a configuration in which an ultrasonic motor and a ball screw are used to move the objective lens along the linear guide in Z direction; and the like.

The vertically reflection mirror 102 is used to guide light emitted by the dark-field illumination unit 101 to the vacuum chamber 6 as shown in FIG. 1. The vertically reflection mirror 102 may have a mechanism for rotating the vertically reflection mirror 102 about two axes, an axis extending in a longitudinal direction of the mirror shown in FIG. 1 and an axis perpendicular to the surface of the sheet of FIG. 1 in order to control the position of a spot of illumination light on the surface of the sample 1.

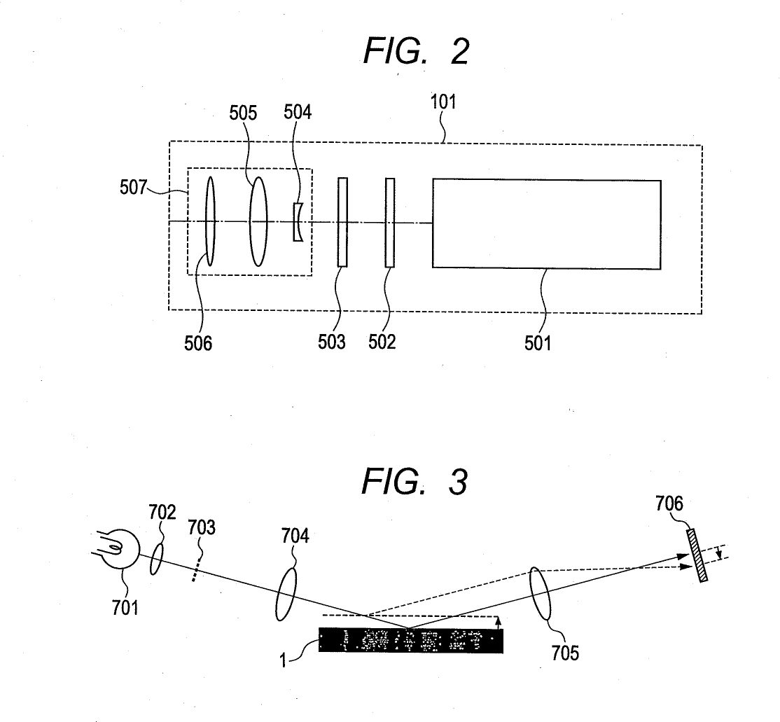

Next, the parts are each described in detail with reference to FIGS. 2 to 20.

FIG. 2 shows the dark-field illumination unit 101 in detail. The dark-field illumination unit 101 includes: an illumination light source 501 that emits a visible light laser, a ultraviolet light laser, a vacuum ultraviolet light laser or the like; an optical filter 502 that adjusts the intensity of the illumination light; a wavelength plate 503 that adjusts the direction of polarization of the illumination light; and a lens group 507 that focuses the illumination light on the sample 1. The lens group 507 includes a plano-concave lens 504, an achromatic lens 505, and a cylindrical lens 506. The lens group 507 is a mechanism capable of controlling a region (to be illuminated) on the surface of the sample 1 in a range from the entire field of view of the optical microscope 14 to a diffraction limit. Specifically, the lens group 507 controls the region (to be illuminated) by selecting a lens focal length and adjusting intervals between the lenses. The region to be illuminated is located on the surface of the sample 1. The cylindrical lens allows a circular region to be illuminated with the emitted light laser to be obliquely incident on the surface of the sample 1.

The illumination light source 501 is a laser oscillator. The laser oscillator oscillates visible light with a wavelength (between 400 nm and 800 nm) of, for example, 405 nm, 488 nm, or 532 nm, or ultraviolet light with a wavelength of 400 nm or less, or vacuum ultraviolet light with a wavelength of 200 nm or less. The laser oscillator can use both continuously oscillated laser and pulse oscillated laser. When the oscillator that uses a continuously oscillated laser is selected and used, an inexpensive, stable, compact device can be achieved. The wavelength of light emitted by the illumination light source 501 is not limited to the aforementioned wavelengths. When high sensitivity is necessary, ultraviolet light is used. In this case, the objective lens 105, the hermetical sealing window 107, the half mirror 108 and the imaging optical system 110 are reflective optical elements or optical elements that support a vacuum ultraviolet range and are made of fused quartz or the like. An optical path in the microscope 14 is entirely arranged in vacuum or in a nitrogen gas atmosphere or the like in order to prevent vacuum ultraviolet light from being absorbed during propagation. Since the purpose is to cause the vacuum ultraviolet light to propagate, the gas with which the optical path is filled is not limited to the nitrogen gas.

When the sample 1 is a mirror-polished wafer, P-polarized laser light is used to illuminate the sample 1. When the surface of the sample 1 is covered with a thin metal film, S-polarized laser light is used to illuminate the sample 1. In order to efficiently observe scattered light and achieve an observation with an excellent S/N ratio, linearly P-polarized light or linearly S-polarized light is used. When S-polarized light is used to observe a mirror-polished wafer, scattering power is low, the absolute amount of scattered light is reduced, and the efficiency is reduced. In this case, P-polarized light is suitable for illumination of the mirror-polished wafer. In contrast, when P-polarized light is used to illuminate and observe a thin metal film or the like, the intensity of light scattered from the substrate is high, and it is not possible to observe a fine defect or a fine foreign material. In this case, S-polarized light is suitable for illumination of the thin metal film or the like.

In addition, in order to suppress light scattered from the substrate, the surface of the substrate is illuminated at a low elevation angle of approximately 10 degrees with respect to the surface of the substrate. The mirror 104 has a mechanism (no shown) for moving the mirror 104 with the objective lens so that when the objective lens 105 moves up and down, a region to be illuminated can be located in the field of view of the objective lens 105. In addition, the mirror 104 may have a mechanism (not shown) for independently moving the mirror 104 so that the position of the region to be illuminated in the field of view of the objective lens 105 can be changed.

FIG. 3 shows the Z sensor 4 or 7. The Z sensor 4 or 7 includes: a light source 701 that emits light to be used to measure the vertical position of the sample; a slit 703; a condenser lens 702 that collects light (to be used to measure the vertical position of the sample) emitted by the light source 701 on the slit 703; light projecting lens 704 that images, on the surface of the sample 1, the light that has passed through the slit 703 as the light to be used to measure the vertical position of the sample; a condenser lens 705 that collects the light (to be used to measure the vertical position of the sample) reflected by the sample 1; and a detector 706 that detects the light (to be used to measure the vertical position of the sample) collected by the condenser lens 705 and converts the detected light into an electrical signal. Information on the light that has been converted into the electrical signal by the detector 706 and is to be used to measure the vertical position of the sample is transmitted to the control system 10, so that the vertical position is calculated. A two-dimensional CCD, a line sensor, or a 2- or 4-division position sensor is used as the detector 706.

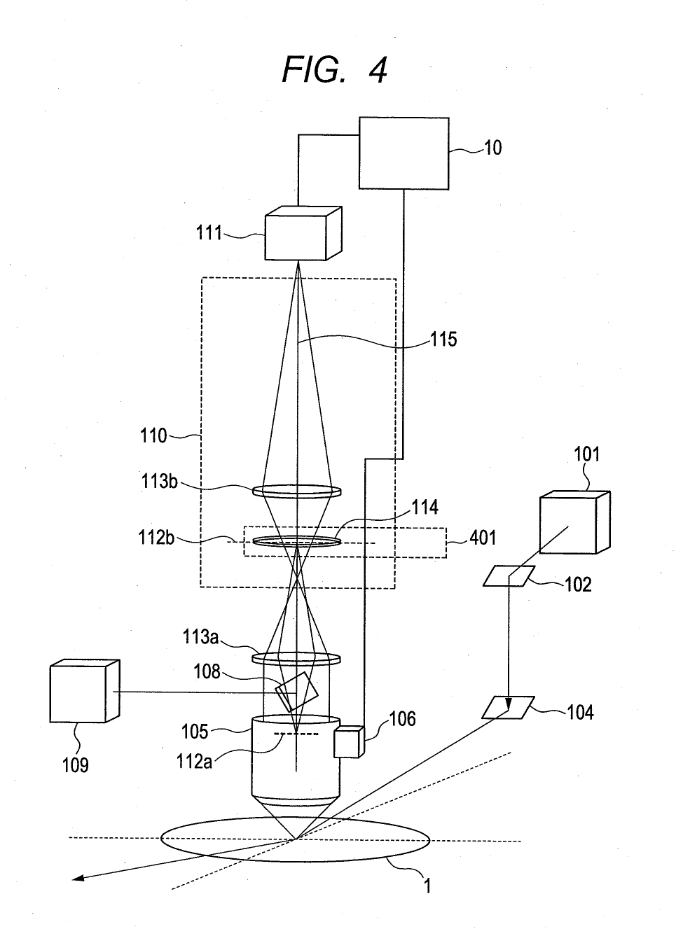

FIG. 4 shows a detailed configuration of the optical microscope 14. The optical microscope 14 includes the dark-field illumination unit 101, the vertically reflection mirror 102, the mirror 104, the objective lens 105, the vertical position control mechanism 106, the half mirror 108, the bright-field illumination light source 109, the imaging optical system 110, and the solid-state imaging element 111. The imaging optical system 110 includes: a lens 113a that extracts a pupil plane 112a of the objective lens 105; a lens 113b that forms an image; and a filter unit 114 that is inserted in the extracted pupil plane 112b. An example of the filter unit 114 is a polarization-distributed polarizer. In the present embodiment, a plurality of distribution polarization elements (four types of polarization-distributed polarizer 114a to 114d in an example shown in FIG. 5) that have different characteristics are held by a holder 402 and can be switched so that any of the polarization-distributed polarizer 114a to 114d is inserted in the pupil plane 112b. In addition, the vertical position control mechanism 106 and the solid-state imaging element 111 are connected to the control system 10.

The lens 113a extracts the pupil plane of the objective lens 105 out of the objective lens 105, and the plane surface is set and used in the imaging optical system 110. Then, the holder 402 is driven, so that a distribution polarization element selected from among the polarization-distributed polarizer 114a to 114d held by the holder 402 is inserted in the pupil plane extracted and set in the imaging optical system 110. The holder 402 may be driven, so that the spatial filter or a distribution polarization element that is formed on a substrate on which the spatial filter is formed is inserted instead of the polarization-distributed polarizer 114a to 114d. A pair of the lenses 113a and 113b image the sample 1 onto a detection surface of the solid-state imaging element 111.

The ratio of reflectance and transmittance of the half mirror 108 may be any value. However, when the intensity of light emitted by the bright-field illumination light source 109 is sufficiently ensured, it is preferable that a large amount of light scattered from a defect be guided to the imaging optical system 110 and the solid-state imaging element 111.

As the bright-field illumination light source 109, a lamp or a laser can be used. When the laser is used, light becomes brighter by replacing the half mirror 108 with a dichroic mirror and a larger amount of scattered light can be guided to the solid-state imaging element 111. In addition, for a dark-field observation, a mechanism (not shown) for removing the half mirror 108 from the optical axis 115 of the imaging optical system 110 and the objective lens 105 may be provided. In this case, there is an advantage that a large amount of scattered light can be guided to the solid-state imaging element 111.

FIG. 5 shows the mechanism 401 for switching the polarization-distributed polarizer 114a to 114d (to be inserted in the pupil plane 112b of the objective lens 105) on the optical axis 115 of the imaging optical system 110. The mechanism 401 includes the holder 402 and a rotating and driving section 403 for rotating the holder 402. The holder 402 holds the plurality of polarization-distributed polarizer 114a to 114d that have different characteristics. The holder 402 is a mechanism for selecting any of the polarization-distributed polarizer 114a to 114d on the basis of the type of a detected fine defect. In contrast, for the bright-field observation, the holder 402 is set at a location at which the polarization-distributed polarizer 114a to 114d are not arranged to perform the observation in order to prevent an image to be acquired from being distorted. The selected distribution polarization element may be set at a location at which parallel plate glass that has a thickness equal to the thicknesses of the polarization-distributed polarizer 114a to 114d is arranged on the holder 402. When the polarization-distributed polarizer 114a to 114d are removed, the length of the optical path is changed and the sample 1 cannot be imaged on the solid-state imaging element 111. In order to avoid preventing the sample 1 from being imaged on the solid-state imaging element 111, the parallel plate glass that has a thickness equal to the thicknesses of the polarization-distributed polarizer 114a to 114d are arranged. The parallel plate glass may not be arranged, and the following mechanism may be provided: a mechanism for adjusting the position of the lens 113b (for forming an image) or the position of the solid-state imaging element 111, so that the sample 1 is imaged on the solid-state imaging element 111.

The example shown in FIG. 5 describes that the polarization-distributed polarizer 114a to 114d that have different characteristics are set to the holder 402. However, instead of the plurality of polarization-distributed polarizer 114a to 114d, a plurality of spatial filters that have different characteristics may be set to the holder 402 and switched. When the spatial filters are set to the holder 402, the bright-field observation is performed while the holder 402 is set at a location at which the spatial filters are not arranged in order to prevent an image to be acquired from being distorted. The selected spatial filter may be set at a location at which parallel plate glass that has a thickness equal to the thicknesses of the spatial filters is arranged on the holder 402. The parallel plate glass may not be arranged, and the following mechanism may be provided: the mechanism for adjusting the position of the lens 113b (for forming an image) or the position of the solid-state imaging element 111, so that the sample 1 is imaged on the solid-state imaging element 111.

FIG. 6 shows another example of the mechanism for setting and removing the polarization-distributed polarizer 114a to 114d. A mechanism 410 is a mechanism for setting and removing a polarization-distributed polarizer 114e on and from the optical axis 115 of the imaging optical system 110 by causing a distribution polarization element holder 405 to slide. In FIG. 6, the single polarization-distributed polarizer 114e is shown. However, a plurality of distribution polarization elements may be set and removed by the mechanism 410. In this example, a spatial filter may be used instead of the polarization-distributed polarizer 114e. Furthermore, the polarization-distributed polarizer 114 and the spatial filter may be combined and used.

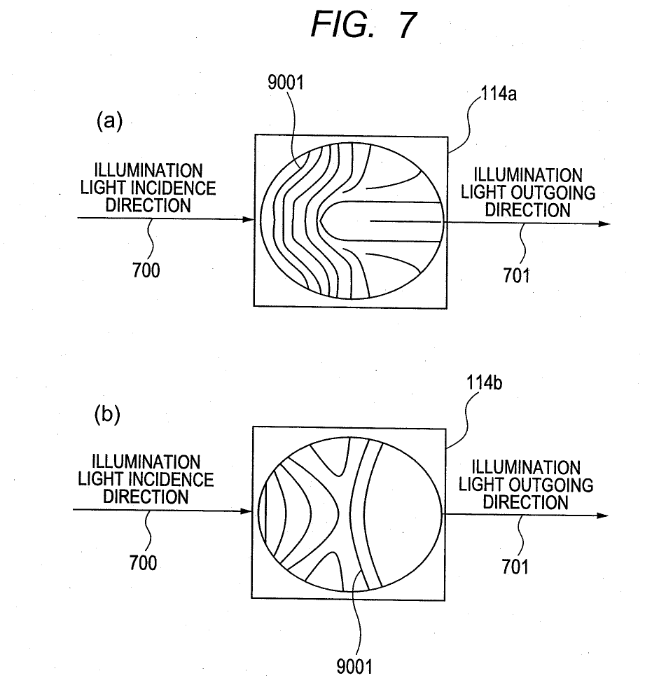

FIGS. 7(a) and 7(b) show polarization characteristics of the polarization-distributed polarizer 114a and 114b inserted in the pupil plane 112b located in the imaging optical system 110. Reference numeral 1002 indicates periphery of the pupil plane. Reference numeral 9001 indicates the direction of a polarized light transmission axis. The polarization-distributed polarizer 114a and 114b each have a diameter that allows the distribution polarization element to cover at least the entire pupil plane 1002. The direction 9001 of the polarized light transmission axis at each of points of the polarization-distributed polarizer 114a is different from the direction 9001 of the polarized light transmission axis at the corresponding point of the polarization-distributed polarizer 114b.

The polarization-distributed polarizer 114a and 114b that have polarized light transmission axes whose directions 9001 are distributed in the surface are each achieved by a combination of linear polarizers, photonic crystal, a wire grid polarizer, or a combination of liquid crystal and polarizers. The photonic crystal is an optical element with fine structures that have different refractive indexes and are arranged at intervals that are equal to or smaller than the wavelength of light. The wire grid polarizer is a polarizing element that includes fine conductive lines periodically arranged and has optical anisotropy.

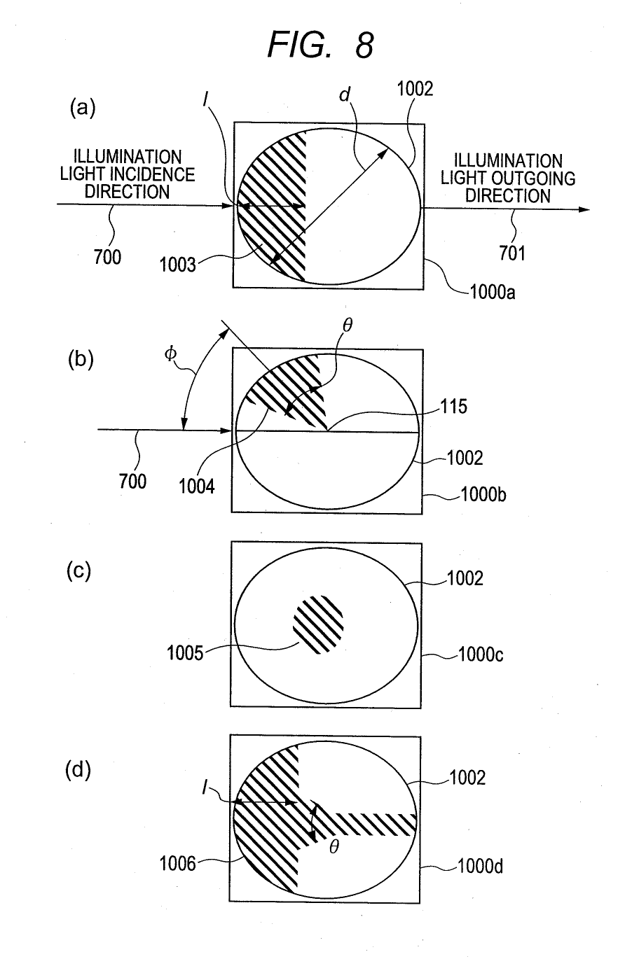

FIGS. 8(a) to 8(d) show an example in which each of spatial filters 1000a to 1000d is inserted in the pupil plane as the filter unit 114 instead of the polarization-distributed polarizer 114a to 114d shown in FIG. 5. In this example, instead of the plurality of polarization-distributed polarizer 114a to 114d, the spatial filters 1000a to 1000d that are formed in different shapes are set to the switching mechanism 401 shown in FIG. 5. In FIGS. 8(a) to 8(d), reference numeral 1002 indicates the periphery of the pupil plane, while reference numerals 1003 to 1006 are light shielding portions.

The following values are determined on the basis of a distribution of the intensity of scattered light: a value l of the light shielding portion 1003 of the spatial filter 1000a shown in FIG. 8(a); and values θ and φ of the light shielding portion 1004 of the spatial filter 1000b shown in FIG. 8(b). The distribution of the intensity of the scattered light is calculated by a scattered-light simulation or the actual measurement.

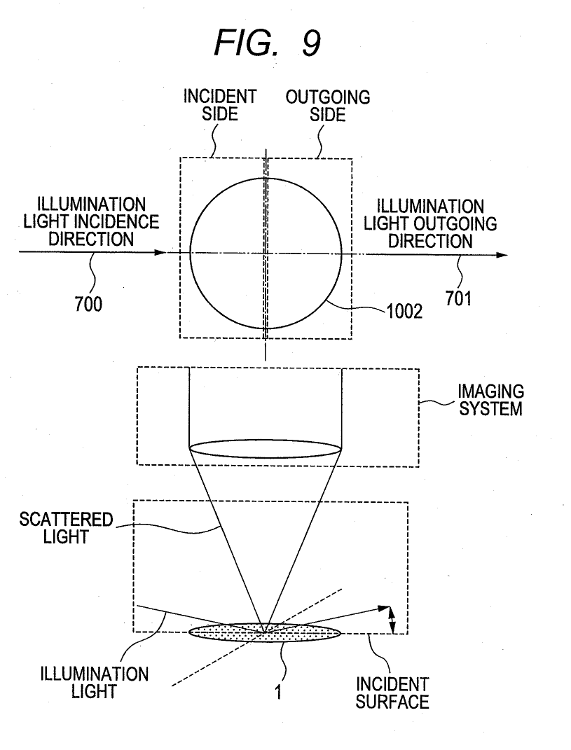

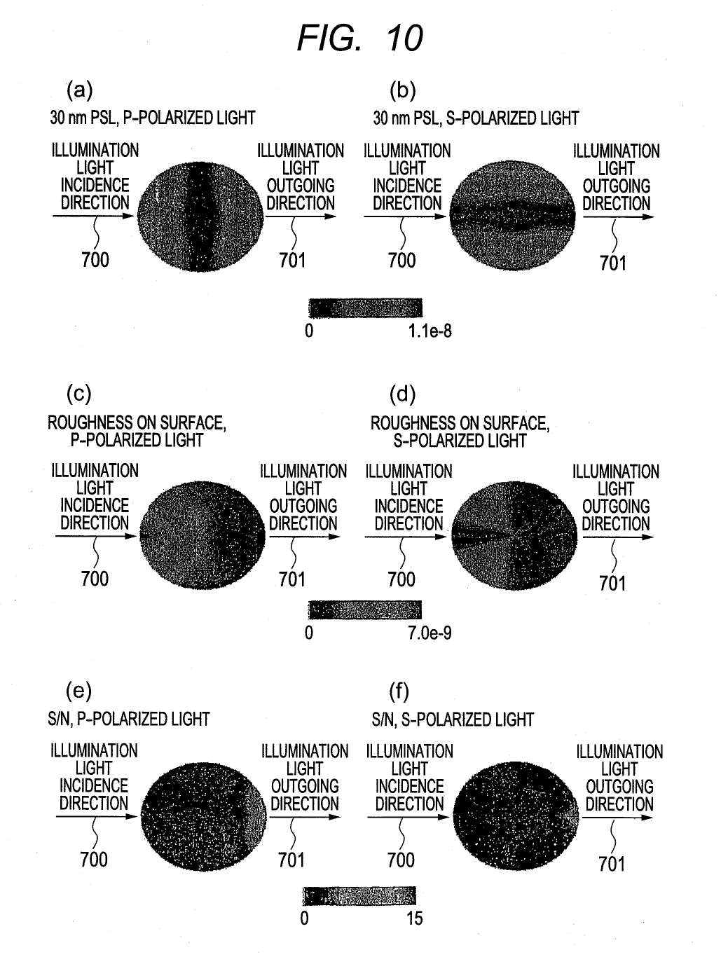

An example of a method for determining the direction 9001 of the polarized light transmission axis and the value l indicating the shape of the spatial filter or the values θ and φ indicating the shape of the spatial filter is described with reference to FIGS. 9 and 10.

First, terms and the scattered-light simulation that is necessary to determine the directions 9001 of the polarized light transmission axes of the polarization-distributed polarizer 114a to 114d are described with reference to FIG. 9. The scattered-light simulation is to illuminate the sample 1 with a laser serving as illumination light from an obliquely upward direction and calculate an intensity distribution and polarization distribution of light scattered from a fine foreign material or fine defect on the sample 1 detected by a surface of an optical element of the imaging optical system. In this case, the surface of the optical element is closest to the sample 1. A component of the scattered light, which is polarized in a direction parallel to the surface on which the light is incident, is P-polarized light. Another component of the scattered light, which is polarized in a direction perpendicular to the direction of the P-polarized light, is S-polarized light. In the following description, among halves of the surface from which the intensity distribution or the polarization distribution is calculated, a half on which illumination light is incident as indicated by reference numeral 700 is called an incident side, and the other half is called an outgoing side.

Next, a method for determining distributions h(r, θ) of the directions of the polarized light transmission axes of the polarization-distributed polarizer 114a to 114d and light shielding regions g(r, θ) of the spatial filters 1000a to 1000d is described.

First, the scattered-light simulation is performed to calculate a distribution fₛ(r, θ) of the intensity of light scattered from a fine defect (to be detected with high sensitivity) or a fine foreign material (to be detected with high sensitivity), a distribution pₛₚ(r, θ) of a P-polarized component of the scattered light, a distribution pₛₛ(r, θ) of a S-polarized component of the scattered light, a distribution f_{N}(r, θ) of the intensity of light scattered from fine roughness present on the surface of the substrate, a distribution p_{Np}(r, θ) of a P-polarized component of the scattered light and a distribution p_{NS}(r, θ) of a S-polarized component of the scattered light.

The distribution h(r, θ) of the directions of the polarized light transmission axes of the polarization-distributed polarizer 114 is determined as a distribution of a polarization axis that causes the largest amount of light scattered from the fine roughness present on the surface of the substrate to be shielded, i.e., a distribution h(r, θ) that minimizes II of Equation 1, or a distribution of a polarization axis that causes the largest amount of light scattered from the fine defect or fine foreign material to be transmitted, i.e., a distribution h(r, θ) that maximizes Λ of Equation 2, or a distribution of a polarization axis that causes the light scattered from the fine roughness present on the surface of the substrate to be shielded and causes the light scattered from the fine defect or fine foreign material to be transmitted, i.e., a distribution h(r, θ) that maximizes Ω of Equation 3.

$$\begin{matrix}II = \int \sqrt{{\vert {P}_{NP} ( r , θ ) \cdot h ( r , θ ) \vert}^{2} + {\vert {P}_{NS} ( r , θ ) \cdot h ( r , θ ) \vert}^{2}} d r d θ & ( Equation 1 ) \\ Λ = \sqrt{{\vert {P}_{SP} ( r , θ ) \cdot h ( r , θ ) \vert}^{2} + {\vert {P}_{SS} ( r , θ ) \cdot h ( r , θ ) \vert}^{2}} d r d θ & ( Equation 2 ) \\ Ω = \frac{\sqrt{{\vert {P}_{SP} ( r , θ ) \cdot h ( r , θ ) \vert}^{2} + {\vert {P}_{SS} ( r , θ ) \cdot h ( r , θ ) \vert}^{2}} d r d θ}{\sqrt{{\vert {P}_{NP} ( r , θ ) \cdot h ( r , θ ) \vert}^{2} + {\vert {P}_{NS} ( r , θ ) \cdot h ( r , θ ) \vert}^{2}} d r d θ} & ( Equation 3 )\end{matrix}$$

In contrast, a method for determining a light shielding region g(r, θ) of the spatial filter is a method for optimizing the light shielding region g(r, θ) or maximizing Ψ of Equation 4, for example.

$$Ψ = \frac{\int {f}_{S} ( r , θ ) \times g ( r , θ ) d r d θ}{\int {f}_{N} ( r , θ ) \times g ( r , θ ) d r d θ} \qquad ( Equation 4 )$$

There is also a method for more simply forming a spatial filter having a distribution that shields a region in which the intensity of light scattered from the fine roughness present on the surface of the substrate is high, or a method for more simply combining a linear polarizer with the spatial filter having the distribution that shields the region in which the intensity of the light scattered from the fine roughness present on the surface of the substrate is high.

Next, a method for determining distributions of the directions of the polarized light transmission axes of the polarization-distributed polarizer 114a to 114d and light shielding characteristics of the spatial filters 1000a to 1000d is described in detail using examples of the results of the scattered-light simulation.

FIGS. 10(a) to 10(f) show examples of distributions of polarization of light scattered from the fine roughness and a fine particle (that is a polystyrene latex particle (hereinafter referred to as PSL)) on the surface of the wafer 1 to be inspected.

FIG. 10(a) shows a distribution of a P-polarized component of the light (illumination wavelength of 400 nm) scattered from the 30 nm PSL. FIG. 10(b) shows a distribution of an S-polarized component of the light scattered from the 30 nm PSL. FIG. 10(c) shows a distribution of a P-polarized component of the light scattered from roughness present on the surface of the wafer 1 to be inspected. FIG. 10(d) shows a distribution of an S-polarized component of the light scattered from the roughness present on the surface of the wafer 1 to be inspected. FIG. 10(e) shows a distribution of the ratio (hereinafter referred to as S/N) of the P-polarized component of the light scattered from the roughness present on the surface of the wafer 1 to be inspected to the P-polarized component of the light scattered from the PSL. FIG. 10(f) shows a distribution of the S/N of the S-polarized components.

From FIGS. 10(a) and 10(b), it is apparent that the intensities of P-polarized components of light that has been scattered from the PSL and reaches outer circumferential portions of the pupil plane on the incident side (indicated by reference numeral 700) of the illumination light and the outgoing side (indicated by reference numeral 701) of the illumination light are high, while the intensities of S-polarized components of light that has been scattered from the PSL and reaches outer circumferential portions (of the pupil plane) sectioned in a direction perpendicular to the direction in which the aforementioned outer circumferential portions are sectioned are high. In contrast, from FIGS. 10(c) and 10(d), it is apparent that the intensity of a P-polarized component of light that has been scattered from the roughness present on the surface of the wafer 1 to be inspected and reaches the pupil plane on the incident side (indicated by reference numeral 700) of the illumination light is high, while the intensities of P- and S-polarized components of light that has been scattered from the roughness present on the surface of the wafer 1 to be inspected and reaches the pupil plane from directions inclined at ±45 degrees with respect to the direction 700 of the incidence of the illumination light are equal and the polarization angle is 45 degrees. In addition, from FIGS. 10(c) and 10(d), it is apparent that the intensity of light that has been scattered from the roughness present on the surface of the wafer 1 to be inspected and reaches the pupil plane on the outgoing side (indicated by reference numeral 701) of the illumination light is low.

The S/N ratios that are calculated from FIGS. 10(a) to 10(d) are shown in FIGS. 10(e) and 10(f). FIG. 10(e) shows the S/N of the P-polarized components, while FIG. 10(f) shows the S/N of the S-polarized components.

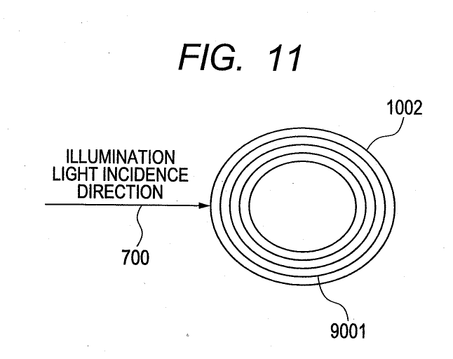

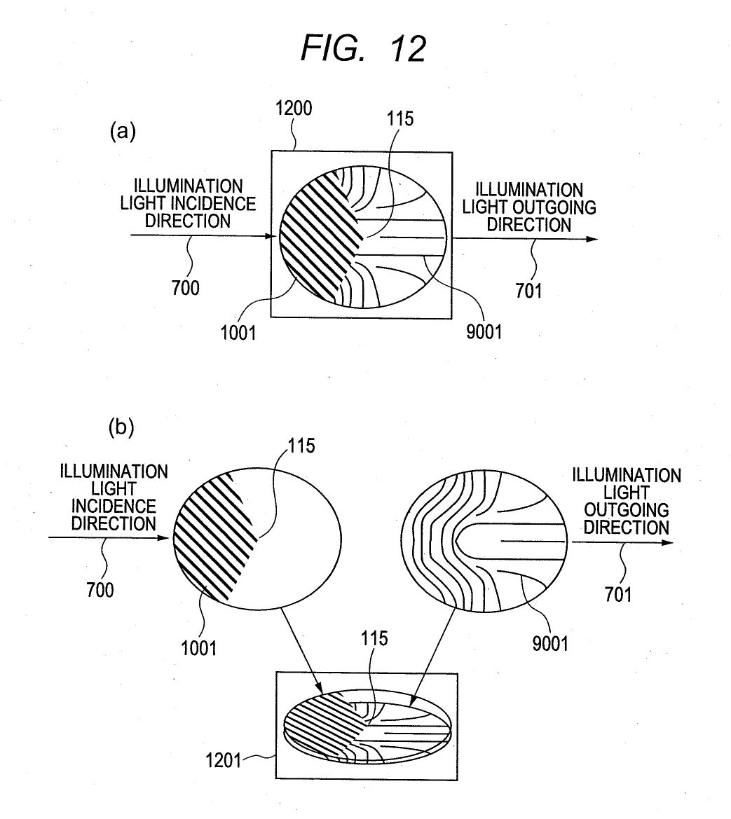

The polarization-distributed polarizer 114 has the distribution of the direction 9001 of the polarized light transmission axis that causes the light scattered from the roughness present on the surface of the wafer 1 (to be inspected) to be shielded. The polarization-distributed polarizer 114 can be determined on the basis of the results shown in FIGS. 10(c) and 10(d) as shown in FIGS. 7(a) and 7(b). FIGS. 7(a) and 7(b) show the profiles of the distributions of the directions 9001 of the polarized light transmission axes of the polarization-distributed polarizer 114 as examples. Reference numeral 1002 indicates an edge of the distribution polarizer, while reference numeral 9001 indicates the direction of the polarized light transmission axis. The polarization-distributed polarizer 114 has a distribution of S-polarized light transmission located on and near a line of intersection of the surface on which the illumination light is incident and the pupil plane. In addition, the polarization-distributed polarizer 114 has a distribution of 45-degree polarized light transmission in the directions inclined at ±45 degrees with respect to the direction 700 of the incidence of the illumination light. In addition, the polarization-distributed polarizer 114 has a distribution of P-polarized light transmission on the pupil plane on the outgoing side (indicated by reference numeral 701) of the illumination light. In addition, the polarization-distributed polarizer 114 has a distribution of S-polarized light transmission on a central portion of the pupil plane and the outer circumferential portions that are included in the pupil plane and sectioned in a direction perpendicular to the direction in which the illumination light is incident. In addition, the profile (of a distribution of the direction 9001 of the polarized light transmission axis), which allows to detect the scattered light from the PSL at maximum effect, is determined on the basis of the characteristics (shown in FIGS. 10(a) and 10(b)) of the distribution of the scattered light. For example, the profile that allows the largest amount of light scattered from the PSL to be received is the direction 9001 of the polarized light transmission axis that extends along the outer circumference of the pupil plane and is concentric with the outer circumference of the pupil plane as shown in FIG. 11.

In addition, the profile of a distribution of the direction 9001 of the polarized light transmission axis, which allows a polarized component of light scattered from the fine defect or fine foreign material to be transmitted, is determined on the basis of the results shown in FIGS. 10(e) and 10(f). In this case, the proportion of the polarized component of the light scattered from the fine defect or fine foreign material to light scattered from the fine roughness present on the surface of the wafer 1 to be inspected is high. For example, the aforementioned distribution profile to be determined is the profile of the distribution of the directions 9001 of the polarized light transmission axes that allow only P-polarized light that reaches the outer circumferential portion of the pupil plane on the outgoing side (indicated by reference numeral 701) of the illumination light to be transmitted.

A distribution of the intensity of scattered light and a distribution of polarized light vary depending on the shape and size of the fine foreign material or fine defect to be detected and an optical characteristic such as a refraction index or the like. Thus, a distribution of polarization of the distribution polarization element to be inserted in the pupil plane located in the imaging optical system is not limited to the distribution profiles (shown in FIGS. 7(a), 7(b) and 11) of the directions 9001 of the polarized light transmission axes.

FIGS. 8(a) to 8(d) show examples of the shapes of the spatial filters 1000a to 1000d. The spatial filters 1000a to 1000d have a diameter d that is equal to or larger than the diameter of the pupil plane. The spatial filters 1000a to 1000d are arranged so that the centers of the spatial filters 1000a to 1000d match the optical axis 115 of the imaging optical system 110. The light shielding portions 1003 to 1006 are included in the spatial filters 1000a to 1000d, respectively. FIG. 8(a) shows the spatial filter 1000a provided with the light shielding portion 1003 that has edges arranged in a direction substantially perpendicular to the direction 700 of the incidence of the illumination light for the dark-field illumination. In the example shown in FIG. 8(a), the spatial filter 1000a is configured so that 1<d/2, and the spatial filter 1000a shields light at a part of the incident side of the pupil plane. The spatial filter 1000a shown in FIG. 8(a) can be used to shield the P-polarized component (shown in FIG. 10(c)) of the light scattered from the fine roughness present on the surface of the wafer 1 to be inspected. In addition, the spatial filter 1000a shown in FIG. 8(a) functions as a spatial filter that shields both P-polarized component and S-polarized component of the light scattered from the fine roughness present on the surface of the wafer 1 to be inspected by setting the diameter so that a half of the diameter d is substantially equal to 1. However, the following spatial filter may be used depending on the shape and size of a fine defect or fine foreign material to be observed or sensitivity required for measurement: a spatial filter that is configured so that 1>d/2. For example, when a component with a high S/N needs to be selectively detected as shown in FIG. 10(e), 0.8d is nearly equal to 1.

FIG. 8(b) shows an example of the spatial filter 1000b provided with the light shielding portion 1004 that shields light at a fan-shaped region defined by the azimuth φ and the apex angle θ in the pupil plane. The spatial filter 1000b shown in FIG. 8(b) is configured so that the center (optical axis 115 of the imaging optical system 110) of the pupil plane matches the apex of the fan-shaped light shielding portion 1004. However, it is not necessary that the apex of the light shielding portion 1004 match the optical axis 115 of the imaging optical system 110. The spatial filter 1000b shown in FIG. 8(b) is an example of a spatial filter that shields only the P-polarized component (shown in FIG. 10(c)) of the light scattered from the fine roughness present on the surface of the wafer to be inspected. The angle θ is determined on the basis of the shape and size of the fine defect or foreign material to be observed or the sensitivity required for measurement, and can be selected from among angles that are larger than 0 degrees and smaller than 360 degrees.

As shown in FIG. 8(c), the spatial filter 1000c that has the island-shaped light shielding portion 1005 in the pupil plane may be used. In addition, the spatial filter 1000d that has the light shielding portion 1006 formed in a shape obtained by combining the spatial filters 1000a to 1000c shown in FIGS. 8(a) to 8(c) may be used.

The light shielding portions 1003 to 1006 of the spatial filters 1000a to 1000d to be inserted in the pupil plane 112b are each constituted by a light shielding plate such as a metal plate subjected to a matte black surface treatment, a combination of a polarizing element and liquid crystal, or a digital mirror array.

Any of the polarization-distributed polarizer 114a to 114d to be inserted in the pupil plane 112b and any of the spatial filters 1000a to 1000d may be formed on the same substrate. FIG. 12(a) shows an example in which any of the polarization-distributed polarizer 114a to 114d and any of the spatial filters 1000a to 1000d are formed on the same substrate as a composite filter 1200. In FIG. 12 showing the composite filter 1200, reference numeral 115 indicates the optical axis of the imaging optical system 110; reference numeral 1001 indicates a light shielding portion; and reference numeral 9001 indicates the direction of a polarized light transmission axis. The composite filter 1200 (shown in FIG. 12(a) as an example) that is configured by forming the spatial filter and the distribution polarization element on the same substrate shields the P-polarized component of the light scattered from the fine roughness present on the surface of the wafer 1 to be inspected. In addition, the composite filter 1200 is a combination of distribution polarization elements and has a polarization distribution that allows the light scattered from the PSL to be selectively received. The composite filter 1200 has a combination of the distribution h(r, θ) (of the polarized light transmission axes of the distribution polarization element) maximizing Ω of Equation 3 and the light shielding region g(r, θ) (of the spatial filter) maximizing Ψ of Equation 4. As a method for forming any of the polarization-distributed polarizer 114a to 114d and any of the spatial filters 1000a to 1000d on the same substrate, photonic crystal, or a polarizing element and liquid crystal, or a combination of a light shielding plate and a wire grid polarizer, or the like can be considered.

Any of the polarization-distributed polarizer 114a to 114d to be inserted in the pupil plane 112b and any of the spatial filters 1000a to 1000d may be combined and simultaneously used. FIG. 12(b) shows an example in which any of the polarization-distributed polarizer 114a to 114d to be inserted in the pupil plane 112b and any of the spatial filters 1000a to 1000d is combined and simultaneously used as a composite filter 1201. In FIG. 12(b) showing the composite filter 1201, reference numeral 115 indicates the optical axis of the imaging optical system 110; reference numeral 1001 indicates a light shielding portion; and reference numeral 9001 indicates the direction of a polarized light transmission axis.

A distribution of the intensity of scattered light varies depending on the shape and size of the fine defect or foreign material to be detected and optical characteristic such as a refraction index. Thus, the light shielding characteristics of the spatial filters to be inserted in the pupil plane 112b located in the imaging optical system are not limited to the shapes shown in FIGS. 8(a) to 8(d). The spatial filter may be formed in any shape as long as the spatial filter shields, on the basis of a distribution characteristic of light scattered from the fine roughness present on the surface of the wafer 1 to be inspected, a component of the scattered light.

Operations of the defect observation device that has the configuration shown in FIG. 1 are described below. First, the sample 1 is transferred through a load lock chamber (not shown) onto the sample holder 2 located in the vacuum chamber 6. Then, the sample 1 is moved by control of the stage 3 into the field of view of the optical microscope 14. At this time, the sample 1 may be not located on the focal point of the optical microscope 14. When the vertical position of the sample 1 is different from the position of the focal point, the objective lens 105 and the mirror 104 are moved in Z direction using the vertical position control mechanism 106 so that the sample 1 is set on the focal point of the optical microscope 14. A method for determining the amount of the movement in Z direction is described later.

It is necessary to perform wafer alignment to match a reference position of the wafer 1 with a reference of the stage 3 in order to observe the defect on the wafer 1 set on the stage 3 of the defect observation device shown in FIG. 1 using positional information about the defect on the wafer 1 detected by another defect inspection device (not shown). The wafer alignment is performed using an image got by bright field observation. In order to perform a bright-field detection, the bright-field illumination light source 109 emits illumination light. The illumination light is reflected by the half mirror 108, and the sample 1 is then illuminated using the objective lens 105. The Light reflected by the sample 1 passes through the imaging optical system 110 and is imaged by the solid-state imaging element 111. The bright-field illumination light source 109 is a lamp, for example. In the bright-field observation according to the present embodiment, the filter 114 to be inserted in the imaging optical system 110 is switched to the parallel plate glass with a thickness that is equal to the thickness of the filter 114. When the alignment is performed on the basis of the outer shape (for example, an orientation flat or a notch when the sample 1 is a wafer) of the sample 1, the process may be performed after an image is acquired on the basis of a positioning point of the sample 1 and several points of the outer shape of the sample 1.

After the wafer alignment, the defect is moved into the field of view of the optical microscope 14 on the basis of the information on the position of the defect detected by the defect inspection device. Then, an image of the defect is acquired by a dark-field observation method performed by the optical microscope 14. In this case, when the vertical positions of portions of the sample at the positions of portions of the defect are different from the position of the focal point of the optical microscope 14, the focal point is adjusted by a method described later.

The dark-field observation method is described below. In the dark-field observation method, the dark-field illumination unit 101 emits illumination light. The illumination light may be laser light or lamp light. However, when the laser light is used, higher illuminance can be obtained. Thus, it is preferable to use the laser light.

The light emitted by the dark-field illumination unit 101 is reflected by the vertically reflection mirror 102, and the light propagates in Z direction. Then, the light passes through the vacuum sealing window 103 and is guided to the vacuum chamber 6. Then, the direction of the propagation of the light is changed by the mirror 104, so that the surface (of the sample 1) that is located on the focal point of the optical microscope 14 is irradiated with the light. Light that is scattered from the sample 1 is collected by the objective lens 105. Then, the scattered light is guided to the imaging optical system 110 and imaged by the solid-state imaging element 111. Then, the light is converted into an electrical signal by the solid-state imaging element 111. Then, the solid-state imaging element 111 transmits the electrical signal to the control system 10.

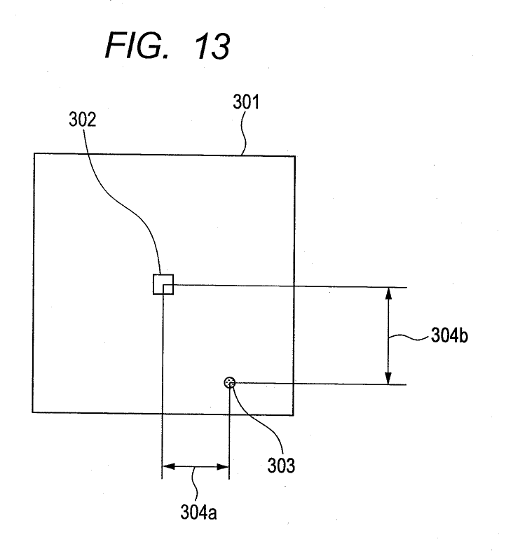

The image that is acquired by the dark-field observation method performed by the optical microscope 14 is accumulated in the control system 10 as a gray image or a color image. As shown in FIG. 13, the control system calculates deviations 304a and 304b of the position of a defect 303 from the position of the center 302 of the field of view 301 of the SEM 5 and registers the deviations as coordinate correction values. After that, the control system 10 moves the sample 1 using the stage 3 and the coordinate correction values so that the defect 303 is set in the field 302 of view 301 of the SEM 5. The defect 303 is then observed by the SEM 5. An image of the observed defect 303 is transmitted to the control system 10, displayed on the user interface 11, registered in the database 12, and subjected to a process of automatically classifying the defect.

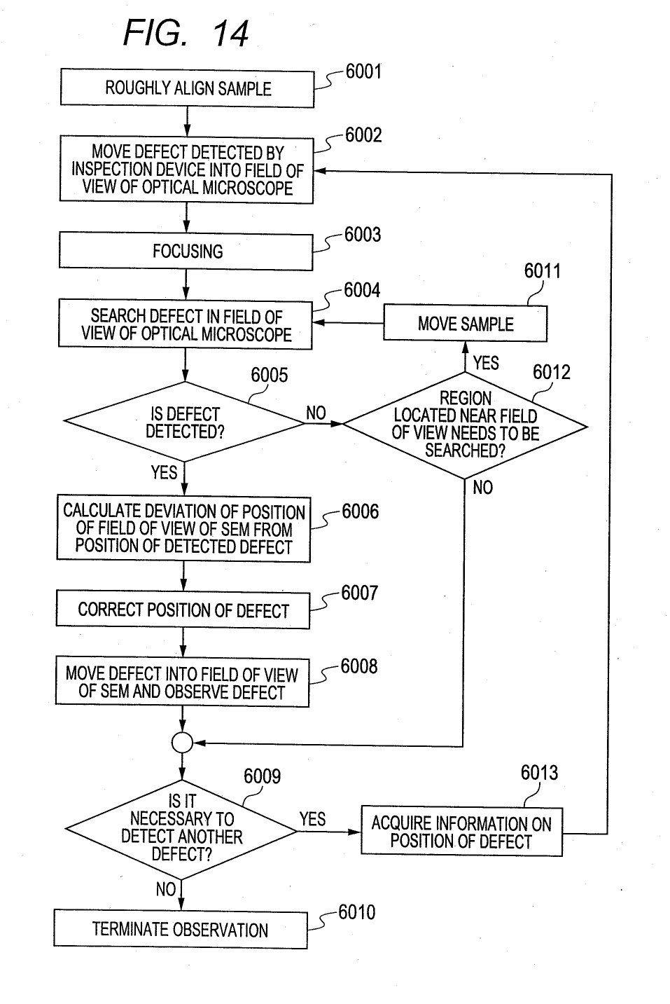

The flow of the observation of the defect is described with reference to FIG. 14.

First, the sample 1 is aligned (6001). The alignment is performed using the aforementioned bright-field observation method that is performed by the optical microscope 14. Next, the stage 3 is moved using the information on the position of the defect detected by the other defect inspection device so that the defect that is present on the sample 1 and is to be observed is set in the field of view of the optical microscope 14 (6002). Then, the objective lens 105 is moved by the vertical position control mechanism 106, and focusing is then performed (6003).

The defect is searched using the image that is acquired by the optical microscope 14 and the solid-state imaging element 111 (6004). When the defect is detected (Yes in 6005), a deviation of the field of view of the SEM 5 from the defect when the SEM 5 tries to observe the defect is calculated from the difference between the position of the defect detected by the optical microscope 14 and the information on the position on the defect detected by the other defect inspection device using the information on the position of the defect detected by the other defect inspection device (6006). The information on the position of the defect detected by the other defect inspection device is corrected on the basis of the calculated deviation (6007). The defect whose positional information is corrected is moved into the field of view of the SEM 5, and the defect is then observed (6008). In this case, information obtained by the observation is transmitted to the control system 10 and registered in the database 11. When many defects to be observed exist, several representative points are extracted from among the defects, deviations of the field of view of the SEM 5 from the positions of the defects detected by the other defect inspection device are calculated on the basis of information on the positions of the extracted defects detected by the defect inspection device and information on the positions of the extracted defects detected by the optical microscope 14. The defects that are not at the representative points and not detected by the optical microscope 14 are detected by the other defect inspection device, and positional information obtained by the detection is corrected.

Next, when defect information is not necessary (NO in 6009), the observation is terminated (6010). When it is necessary to perform an observation (YES in 6009), information on the position of a defect to be observed is acquired, and the process returns to the aforementioned step of moving the defect into the field of view of the optical microscope 14 and is progressed. When the defect cannot be detected in the step of detecting the defect (No in 6005), it is considered that the defect is set out of the field of view of the optical microscope 14. Thus, a region located near the field of view of the optical microscope 14 may be searched. When the region located near the field of view of the optical microscope 14 needs to be searched (Yes in 6012), the sample 1 is moved by a distance corresponding to the field of view (6011), and the process is performed from the step of detecting the defect. When the region located near the field of view of the optical microscope 14 does not need to be searched (No in 6012), the process is progressed according to the procedures.

There is also a method for calculating correction amounts of the positions of the defects in advance, registering the correction amounts in the database, and detecting and observing two or more or all of the defects using the SEM 5 after the calculation of the correction amounts of the positions of the two or more or all of the defects.

Next, a method for calculating a Z position is described below. FIG. 3 shows the configurations of the Z sensors 4 and 7. The Z sensors 4 and 7 each include the light source 701, the condenser lens 702, the slit 703, the illumination lens 704, the condenser lens 705 and the detector 706. The illumination light source is a laser oscillator or a lamp, for example. The detector 706 is a CCD camera, a CCD linear sensor or the like.

Operations of the Z sensors 4 and 7 are described below. Light that is emitted by the illumination light source 701 passes through the condenser lens 702 so that the slit 703 is irradiated with the light. The light is focused on the surface of the sample 1 by the illumination lens 704. Then, the light that is reflected by the surface of the sample 1 passes through the condenser lens 705 and is focused on the detector 706. As the method for calculating the Z position, the position of the detected light on the detector 706 when the vertical position of the sample 1 is set to a standard vertical position is stored. Next, when the vertical position is changed, the position of the detected light on the detector 706 is changed. Thus, the vertical position of the sample 1 can be calculated on the basis of the change in the position of the detected light by measuring the relationship between the amount of the change in the position of the detected light and the amount of the change in the vertical position of the sample 1 in advance.

The present embodiment describes that the observation is performed using the SEM. A method and a device, which allow an observation to be performed in more detail than the optical observation method, can be used, such as another electron microscope such as an STEM, a microfabricated device using a focused ion beam, an analyzing device using an X ray analyzer, and the like.

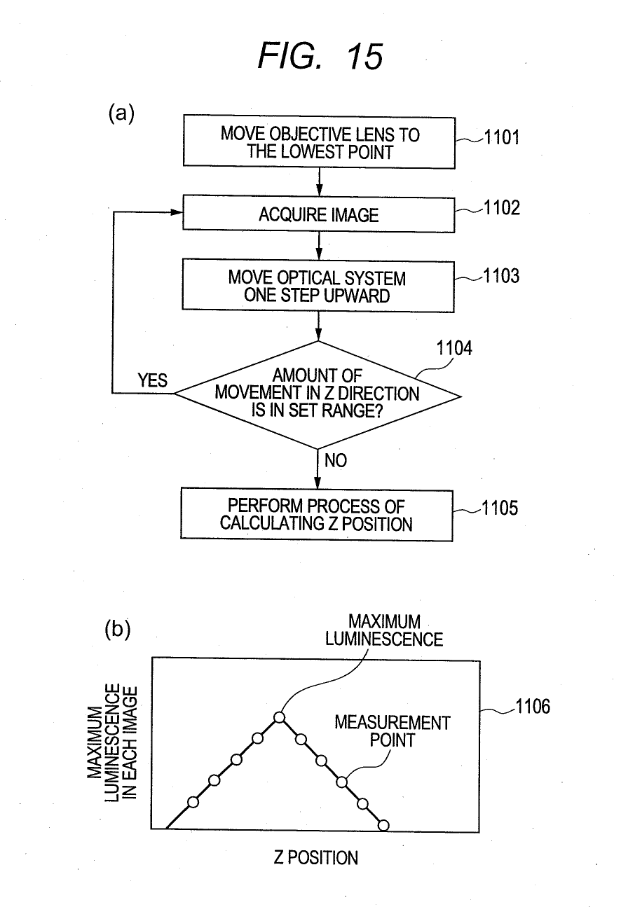

Another method for calculating the Z position is described with reference to FIGS. 15(a) and 15(b). FIGS. 15(a) and 15(b) show procedures of the method for calculating the Z position. This method uses an image acquired by the optical microscope. First, the objective lens 105 is moved to the lowest point (point at which a distance between the objective lens 105 and the sample 1 is the shortest) using the Z control mechanism 106(1101). Next, the detector 706 acquires an image and transmits the image to the control system 10 (1102). At this time, when an edge of the sample or a circuit pattern is located in the field of view, it is preferable to use an image acquired by the bright-field observation. When the edge of the sample and the circuit pattern are not located in the field of view, it is preferable to use an image acquired by the dark-field observation. After an image is acquired, the objective lens 105 is moved one step upward by the Z control mechanism 106 (1103). The one step corresponds to resolution for detection of the Z position and is preferably equal to or smaller than a half of the focal depth of the objective lens 105. After the objective lens 105 is moved, an image is acquired again. A range of the movement in Z direction and a range to be imaged are set in advance. When the amount of the movement in Z direction exceeds the set range, the acquisition of the image is terminated (1104), and the process proceeds to a process of calculating the Z position (1105).

The process of calculating the Z position is described. First, a point that has the maximum luminescence is searched from each of the acquired images. The maximum luminescence and the Z positions corresponding to the points having the maximum luminescence are plotted in a graph (1106). The maximum luminescence in the graph 1106 is calculated. In this case, it is preferable to calculate a point with the maximum luminescence by approximating the measured points using a curved line. The Z position that corresponds to the calculated point with the maximum luminescence is a position at which the focal point of the objective lens 105 best matches the surface of the sample 1.

When the aforementioned method for calculating the Z position is used, the Z sensor 7 may be omitted, so that the configuration is simple.

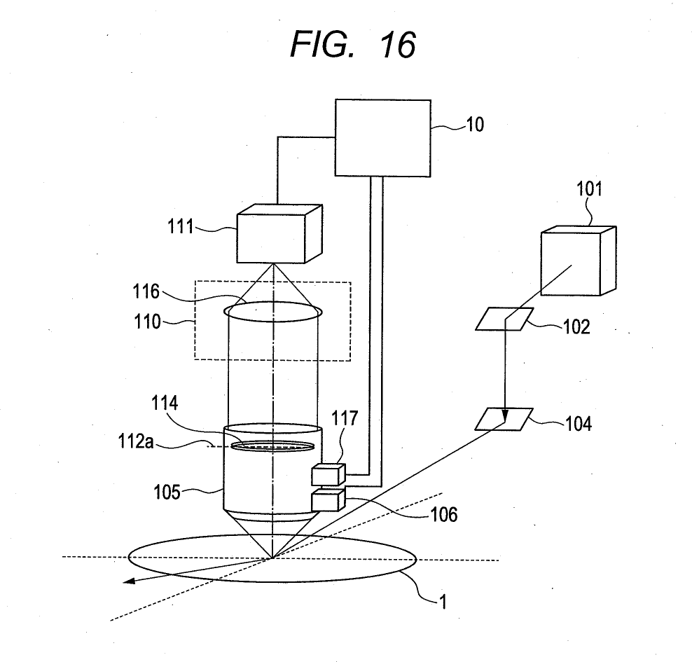

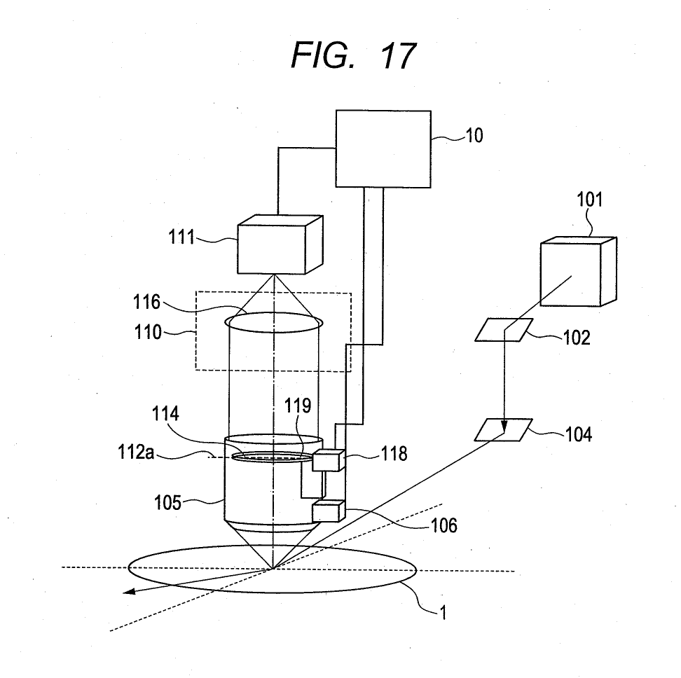

A second example of the configuration of the optical microscope 14 according to the present embodiment is described with reference to FIG. 16. The optical microscope 14 includes the dark-field illumination unit 101, the vertically reflection mirror 102, the mirror 104, the objective lens 105, the vertical position control mechanism 106, the imaging optical system 110, the solid-state imaging element 111, an objective lens rotating mechanism 117 and a liquid crystal control device 118. The imaging optical system 110 is constituted only by an imaging lens 116. The polarization-distributed polarizer 114 is fixed to the pupil plane 112a of the objective lens 105.

In this case, a lens system for extracting the pupil plane 112a of the objective lens 105 out of the objective lens, the half mirror 108 and the bright-field illumination light source 109 are omitted, so that there is an advantage that the configuration is simple.

In this case, the mechanism 117 for rotating the objective lens 105 about a central axis of the objective lens 105 in order to adjust an angle of the polarization-distributed polarizer 114 may be provided. In this case, the rotating mechanism 117 is connected to the control system 10.

A third example of the configuration of the optical microscope 14 according to the present embodiment is described with reference to FIG. 17. The optical microscope 14 includes the dark-field illumination unit 101, the vertically reflection mirror 102, the mirror 104, the objective lens 105, the vertical position control mechanism 106, the imaging optical system 110, the solid-state imaging element 111, the liquid crystal control device 118 and a polarizing plate 119. The imaging optical system 110 includes the imaging lens 116. As the polarization-distributed polarizer 114, a liquid crystal element is fixed to the pupil plane 112a of the objective lens 105. In this case, there are the following advantages. The polarized light transmission axis of the distribution polarization element can be controlled by a combination of the polarizing plate 119 and the liquid crystal control device 118 arranged outside the objective lens as shown in FIG. 17. The bright-field observation can be performed by setting a polarization characteristic of liquid crystal to non-polarization. A high-sensitivity dark-field observation can be performed when the liquid crystal has a polarization characteristic. The liquid crystal control device 118 is connected to the control system 10. In this case, there is an advantage that the objective lens rotating mechanism 117 can be omitted. In order to perform the bright-field observation, the half mirror 108 and the bright-field illumination light source 109 are used in the configuration.

### Second Embodiment

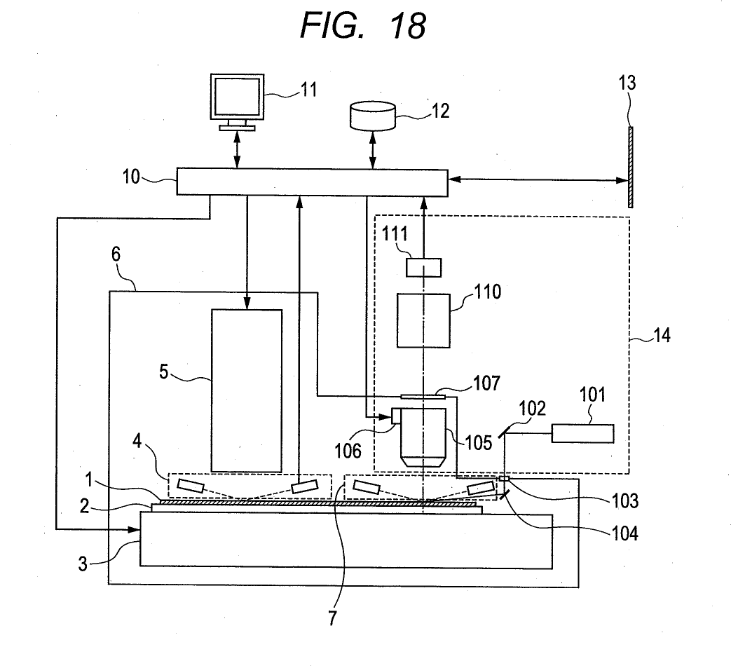

Next, a second embodiment of the defect inspection device according to the present invention is described below with reference to FIG. 18. In the second embodiment, the half mirror 108 and the bright-field illumination light source 109 are not arranged. This feature is different from the first embodiment. Thus, there is an advantage that a simple configuration shown in FIG. 18 is provided. In the configuration shown in FIG. 18, parts that are indicated by the same reference numerals as those shown in FIG. 1 have the same functions as those described with reference to FIG. 1.

In this case, the focal point of the optical microscope 14 is adjusted using the Z sensor 7 or through image processing that is performed on the basis of the dark-field image acquired by the optical microscope 14.

In this case, the optical microscope 14 may be configured so that the polarization-distributed polarizer 114 is fixed to the pupil plane 112a of the objective lens 105 as shown in FIG. 16.

### Third Embodiment

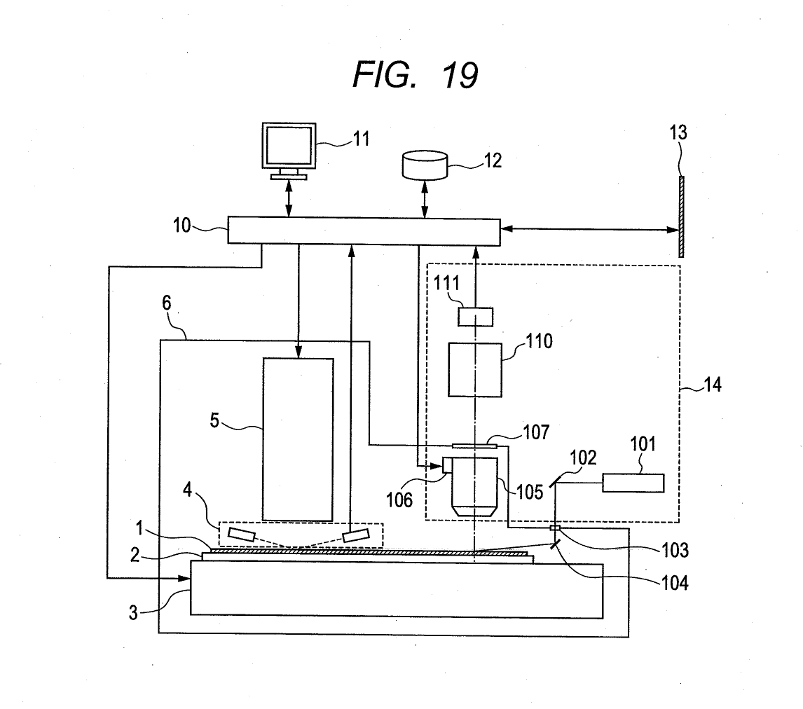

A third embodiment of the defect inspection device according to the present embodiment is described with reference to FIG. 19. In the third embodiment, the Z sensor 7, the half mirror 108 and the bright-field illumination light source 109, which are included in the microscope 14, are not arranged. This feature is different from the first embodiment. Thus, there are the following advantages. A simple configuration shown in FIG. 19 is provided, and a space that allows the objective lens 105 to have a larger numerical aperture is ensured. In the configuration shown in FIG. 19, parts that are indicated by the same reference numerals as those shown in FIG. 1 have the same functions as those described with reference to FIG. 1.

In this case, the focal point of the optical microscope 14 is adjusted using the Z sensor 4 or through image processing that is performed on the basis of the dark-field image acquired by the optical microscope 14.

In this case, the optical microscope 14 may be configured so that the polarization-distributed polarizer 114 is fixed to the pupil plane 112a of the objective lens 105 as shown in FIG. 16.

### Fourth Embodiment

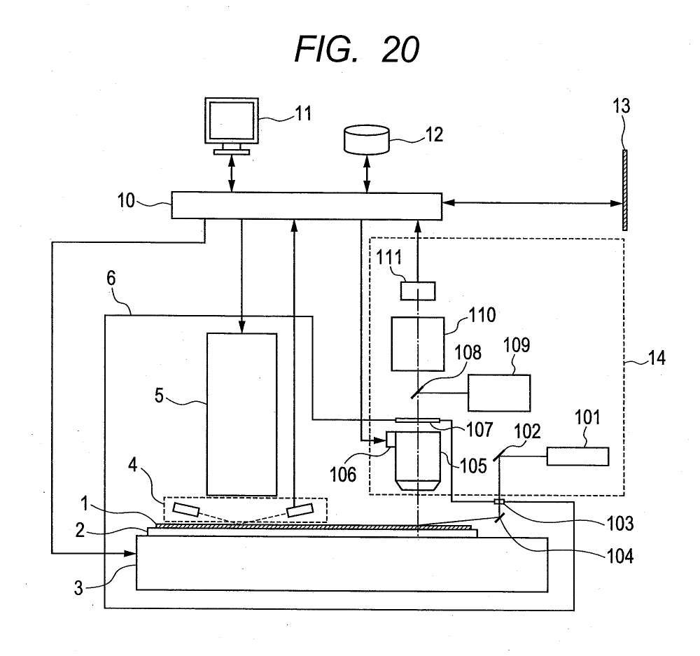

A fourth embodiment of the defect inspection device according to the present invention is described with reference to FIG. 20. In the fourth embodiment, the Z sensor 7 of the microscope 14 is not arranged. This feature is different from the first embodiment. Thus, there are the following advantages. A simple configuration shown in FIG. 20 is provided, and a space that allows the objective lens 105 to have a larger numerical aperture is ensured. In the configuration shown in FIG. 20, parts that are indicated by the same reference numerals as those shown in FIG. 1 have the same functions as those described with reference to FIG. 1.

In this case, the focal point of the optical microscope 14 is adjusted through image processing that is performed on the basis of the bright- or dark-field image acquired by the optical microscope 14.

In this case, the optical microscope 14 may be configured so that the polarization-distributed polarizer 114 is fixed to the pupil plane 112a of the objective lens 105 as shown in FIG. 16.

1. A defect observation device comprising:
optical microscope means;
SEM observation means; and
stage means that holds a sample and is capable of moving between the optical microscope means and the SEM observation means;
the defect observation device observing a defect on the sample using positional information about the defect on the sample, the defect on the sample having originally been detected by other inspection device,
wherein the optical microscope means includes a dark-field illumination optical system that detects the defect by a dark-field illumination using the positional information about the defect on the sample detected by the other inspection device, and
wherein the dark-field illumination optical system includes: a polarized-light illuminating section that illuminates the sample with polarized light; and a detection optical system that detects light reflected and scattered from the sample illuminated with the polarized light by the polarized-light illuminating section while shielding or reducing a specific polarized component of the reflected and scattered light.

2. The defect observation device according to claim 1,
wherein the detection optical system transmits a polarized component of light scattered from a fine defect or a fine foreign material present on the sample by shielding or reducing the specific polarized component of light reflected and scattered from the sample, the proportion of the polarized component of the light scattered from the fine defect or the fine foreign material to the light scattered from the sample being high.

3. The defect observation device according to claim 2,
wherein the detection optical system transmits the polarized component of the light scattered from the fine defect or the fine foreign material present on the sample by means of a distribution polarization element having a polarized light transmission axis extending in a direction varying depending on a location, the proportion of the polarized component of the light scattered from the fine defect or the fine foreign material to the light scattered from the sample being high.

4. The defect observation device according to claim 2,
wherein the detection optical system shields or reduces a polarized component of light reflected and scattered from fine roughness present on the surface of the sample by means of a polarization-distributed polarizer having a polarized light transmission axis extending in a direction varying depending on a location, the proportion of the polarized component to the light reflected and scattered from the fine roughness present on the surface of the sample being high.

5. The defect observation device according to claim 2,
wherein the detection optical system shields or reduces light reflected and scattered from fine roughness present on the surface of the sample, and transmits light reflected and scattered from the defect present on the surface of the sample by means of a spatial filter.

6. The defect observation device according to claim 2,
wherein the detection optical system selectively transmits the polarized component of the light scattered from the fine defect or the fine foreign material present on the sample, and shields or reduces light reflected and scattered from fine roughness present on the surface of the sample by simultaneously using a spatial filter and a polarization-distributed polarizer with a polarized light transmission axis extending in a direction varying depending on a location, the proportion of the polarized component to the light scattered from the sample being high.

7. The defect observation device according to claim 1,
wherein the polarized-light illuminating section emits a polarized laser and performs a dark-field illumination on the sample with the polarized laser.

8. A defect observation method in which an optical microscope detects the position of a defect using positional information about the defect on a sample, the defect on the sample having originally been detected by other inspection device, the positional information about the defect on the sample detected by the other inspection device is modified, and the defect whose positional information has been modified is observed by an SEM, the method comprising the steps of:
causing the optical microscope to perform a dark-field illumination with polarized light using the positional information about the defect on the sample detected by the other inspection device; and
detecting light reflected and scattered from the sample illuminated by the dark-field illumination with the polarized light while shielding or reducing a specific polarized component of the reflected and scattered light, and thereby detecting the defect on the sample detected by the other inspection device.

9. The defect observation method according to claim 8, further comprising the step of shielding or reducing the specific polarized component of the light reflected and scattered from the sample illuminated by the dark-field illumination with the polarized light, and thereby transmitting a polarized component of light scattered from a fine defect or a foreign material present on the sample and detecting the light scattered from the fine defect or the foreign material present on the sample, the proportion of the polarized component of the light scattered from the fine defect or the foreign material to the light scattered from the sample being high.

10. The defect observation method according to claim 9,
wherein the specific polarized component of the light reflected and scattered from the sample is shielded or reduced by causing a polarization-distributed polarizer with a polarized light transmission axis extending in a direction varying depending on a location to shield or reduce a specific polarized component of light reflected and scattered from fine roughness present on the surface of the sample.

11. The defect observation method according to claim 9,
wherein the specific polarized component of the light reflected and scattered from the sample is shielded or reduced by causing a spatial filter to shield or reduce the light reflected and scattered from the surface of the sample and transmit light reflected and scattered from the defect present on the surface of the sample.

12. The defect observation method according to claim 9,
wherein the specific polarized component of the light reflected and scattered from the sample is shielded or reduced by using a combination of a spatial filter and a polarization-distributed polarizer with a polarized light transmission axis extending in a direction varying depending on a location, and thereby selectively transmitting the polarized component of the light scattered from the fine defect or the fine foreign material present on the sample and shielding or reducing light reflected and scattered from fine roughness present on the surface of the sample, the proportion of the polarized component of the light scattered from the fine defect or the fine foreign material to the light scattered from the sample being high.

13. The defect observation method according to claim 9,
wherein the dark-field illumination with the polarized light is performed by performing a dark-field illumination on the sample with a polarized laser.
